(19) United States
(12) Patent Application Publication
(10) Pub. No.: US 2011/0087692 A1
(43) Pub. Date: Apr. 14, 2011

(54) APPLICATION WHITELISTING IN A CLOUD-BASED COMPUTING DEVICE

(75) Inventor: Christopher Masone, Burlingame, CA (US)

(73) Assignee: GOOGLE INC., Mountain View, CA (US)

(21) Appl. No.: 12/903,189

(22) Filed: Oct. 12, 2010

Related U.S. Application Data
(60) Provisional application No. 61/360,760, filed on Jul. 1, 2010.
(60) Provisional application No. 61/251,292, filed on Oct. 13, 2009.

(51) Int. Cl. G06F 15/173; G06F 17/30

(52) U.S. Cl. 707/769; 709/224; 707/E17.014

(57) ABSTRACT

Methods and apparatus for obtaining and executing application programs for use on a cloud-based computing device are disclosed. An example method includes receiving, by a computing device, a request to obtain an application for execution on the computing device. The example method further includes sending, from the computing device to a first server, the request to obtain the application. The example method also includes receiving, by the computing device from the first server, the application. The example method still further includes sending, by the computing device to one or more cloud-based sources, a request for one or more metrics associated with the application and receiving, by the computing device from the one or more cloud-based sources, the one or more metrics. The example method yet further includes determining, by the computing device, whether to execute the application based on the one or more metrics.

### CROSS-REFERENCE TO RELATED APPLICATIONS

This application claims the benefit, under 35 U.S.C. §119(e), of U.S. Provisional Patent Application Ser. No. 61/251,292, filed on Oct. 13, 2009 and U.S. Provisional Patent Application Ser. No. 61/360,760, filed on Jul. 1, 2010. The disclosures of U.S. Provisional Patent Application Ser. Nos. 61/251,292 and 61/360,760 are incorporated by reference herein in their entirety.

### TECHNICAL FIELD

This application relates, in general, to execution of software applications in a cloud-based computing environment.

### BACKGROUND

With the creation of the World-Wide-Web (WWW) and high speed computer networks, the paradigm for personal computer usage has dramatically shifted. In the past, users would primarily use their personal computers to run programs, and store and manipulate data that was located on their local hard-drive. Only rarely would users store or manipulate data located on a network-accessible drive, or run a program that was provided as a network service, and even then, such programs and data were usually restricted to a local area network.

Today, more and more users are storing more and more data on remote data servers, and using remotely provided web-based applications (e.g., SaaS or Software as a Service programs) to manipulate and organize that data. For example, many users today store their personal email and contact information, and even pictures, videos, and music archives on remote servers, and access that data using third party applications that are provided through and controlled by a web-browser.

Cloud computing is a style of computing in which computing resources such as application programs and file storage are remotely provided over the Internet, typically through a web browser. Many web browsers are capable of running applications (e.g., Java applets), which can themselves be application programming interfaces (“API's”) to more sophisticated applications running on remote servers. In the cloud computing paradigm, a web browser interfaces with and controls an application program that is running on a remote server (or in a network “cloud”). Through the browser, the user can create, edit, save and delete files on the remote server via the remote application program.

Due to this shift in computer usage, today's computer users are unlikely to want or need many of the features and functions provided by modern operating systems. These users do not need to worry about file structures on their computing devices or organizing or backing up their data, because much of their data is stored, organized and backed up for them on the cloud. Such users do not need to worry about loading and updating software, because most of the software they use is provided to them when needed as a cloud-based service. Instead, today's computer users are more interested in quickly logging onto their computer, launching a web browser, and accessing data and programs of interest to them, which are becoming more and more readily accessible through the WWW.

### SUMMARY

In a first general aspect, an example method for obtaining and executing a cloud-based computing application may include receiving, by a computing device, a request to obtain the application for execution on the computing device. The example method may further include sending, from the computing device to a first server, the request to obtain the application. The example method may also include receiving, by the computing device from the first server, the application. The example method may still further include sending, by the computing device to one or more cloud-based sources, a request for one or more metrics associated with the application and receiving, by the computing device from the one or more cloud-based sources, the one or more metrics. The example method may yet further include determining, by the computing device, whether to execute the application based on the one or more metrics.

In a second general aspect an example method for obtaining and executing a cloud-based computing application may include receiving, at a cloud-based computing device, a request to obtain an application for execution on the cloud based computing device. The example method may also include sending, from the computing device to a server, the request and receiving, by the computing device from the server, the application. The example method may further include determining, by the computing device, an identifying attribute of the application and searching, by the computing device, a database of approved applications for the identifying attribute. The example method may still further include, in the event the identifying attribute is included in the database, executing the application on the computing device.

In a third general aspect, an example machine readable storage medium has instructions stored thereon. The instructions, when executed by a processor of a computing device, may cause the computing device to receive a request to obtain an application for execution on the computing device and send, to a first server, the request to obtain the application. The instructions, when executed, may also cause the computing device to receive, from the first server, the application. The instructions, when executed, may further cause the computing device to send, to one or more cloud-based sources, a request for one or more metrics associated with the application and receive, from the one or more cloud-based sources, the one or more metrics. The instructions, when executed, may still further cause the computing device to determine whether to execute the application based on the one or more metrics.

In a fourth general aspect, an example machine readable storage medium has instructions stored thereon. The instructions, when executed by a processor of a computing device, may cause the computing device to receive a request to obtain an application for execution on the computing device, send the request to a server and receive the application from the server. The instructions, when executed, may further cause the computing device to determine an identifying attribute of the application and search a database of approved applications for the identifying attribute. The instructions, when executed may also cause the computing device to, in the event the identifying attribute is included in the database, execute the application.

In a fifth general aspect, an example computing device may be configured to implement a method for obtaining and executing a cloud-based computing application. The example computing device may be configured to receive a request to obtain the application for execution on the computing device. The example computing device may be further configured to send, to a first server, the request to obtain the application. The example computing device may also be configured to receive, from the first server, the application. The example computing device may be still further configured to send, by the computing device to one or more cloud-based sources, a request for one or more metrics associated with the application and receive, from the one or more cloud-based sources, the one or more metrics. The example computing device may be yet further configured to determine whether to execute the application based on the one or more metrics.

In a sixth general aspect, an example computing device may be configured to implement a method for obtaining and executing a cloud-based computing application. The example computing device may be configured to receive, at a cloud-based computing device, a request to obtain an application for execution on the cloud based computing device. The example computing device may also be configured to send, to a server, the request and receive, from the server, the application. The example computing device may be further configured to determine an identifying attribute of the application and search a database of approved applications for the identifying attribute. The example computing device may be still further configured to, in the event the identifying attribute is included in the database, execute the application on the computing device.

### BRIEF DESCRIPTION OF THE DRAWINGS

FIG. 1 is a block diagram illustrating a computing network in accordance with an example embodiment.

FIG. 2 is a diagram illustrating a server and database record in accordance with an example embodiment.

FIGS. 3A and 3B are diagrams illustrating a computing device that may implement the techniques described herein in accordance with an example embodiment.

FIG. 4 is a flowchart illustrating a method for executing an application in a cloud-based computing environment in accordance with an example embodiment.

FIG. 5 is a flowchart illustrating a method for determining whether to approve an application for execution in accordance with an example embodiment.

FIG. 6 is a flowchart illustrating a method for publishing user ratings of an application in accordance with an example embodiment.

FIG. 7 is a flowchart illustrating another method for determining whether to approve an application for execution in accordance with an example embodiment.

FIG. 8 is a flowchart illustrating a method for obtaining metrics for an application, determining whether to execute the application based on the metrics and adding an approved application to a database of approved applications in accordance with an example embodiment.

FIG. 9 is a flowchart illustrating another method for obtaining metrics for an application and determining whether to execute the application based on the metrics in accordance with an example embodiment.

FIG. 10 shows an example of a computing device and a mobile computing device that can be used to implement the techniques described herein.

Like reference symbols in the various drawings indicate like elements.

### DETAILED DESCRIPTION

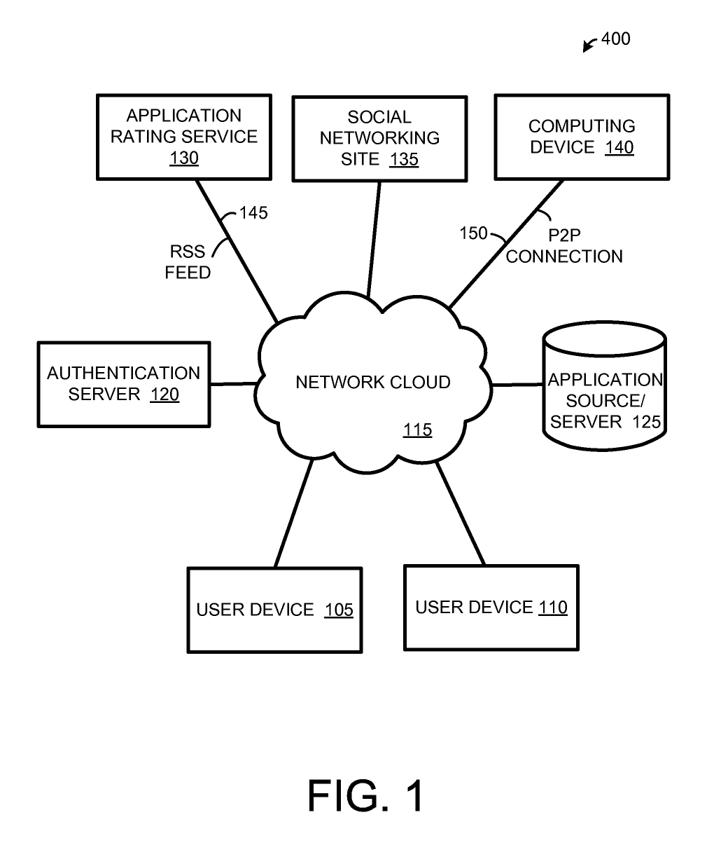

FIG. 1 is a block diagram illustrating a cloud-based computing network 100 in accordance with an example embodiment. As shown in FIG. 1, the network 100 includes two user computing devices 105 and 110. The computing devices 105 and 110 may be computing devices that are commonly owned, such as by a single user. As shown in FIG. 1, the computing devices 105 and 110 are coupled with a network cloud 115, via which the computing devices 105 and 110 may communicate with the other elements of the network 100, such as using the approaches described herein, for example.

In the network 100, a user of the computing devices 105 and 110 may have a cloud-based computing account, where account information for the user is maintained on an authentication server 120. For example, the authentication server 120 may maintain user login credentials that are used to authenticate the user when accessing his or her cloud-based computing devices and/or account. The authentication server 120 may also maintain information for the user regarding applications that are preapproved (“whitelisted”) for execution on the computing devices 105 and 110, or on any cloud-based computing device the user may use to log into his or her cloud-based computing account.

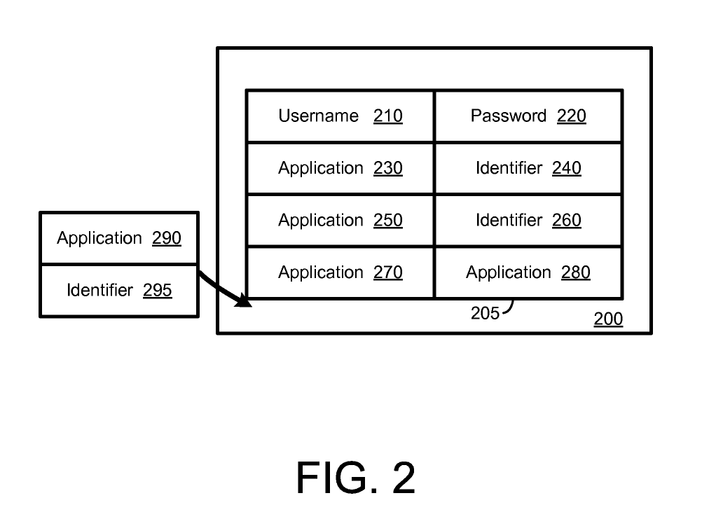

For example, the authentication server 120 may include a database of users, where the database includes respective database records associated with each user's account credentials. In such an approach, each database record may list respective whitelisted applications for each user. An example embodiment of such a database record is illustrated in FIG. 2 and described in further detail below. Using such an approach, the user device 105 (or the user device 110) may communicate with the authentication server 120 to log a user into his or her cloud-based computing account. Once the user has been authenticated, the authentication server 120 may send the user's database record of whitelisted applications to the user device 105, the user device 110 or other computing device from which the user has logged into his or her account.

In the network 100, a user may request, e.g., using the user device 105, to run a cloud-based application. In one embodiment, the user could make such a request, for example, by clicking a browser link associated with the application, or using a number of other appropriate techniques, such as by selecting an icon corresponding with the application. The user could also make a request to execute an application using the computing device 110, or another computing device. In one embodiment, the requested application may be a browser-based application that runs within a web browser operating on the user device 105. In other embodiments, the requested application may be a conventional application that runs as an independent process (e.g., not within a browser).

Such a request to execute the application may take a number of forms. For example, the request may simply include a name of the desired application. In other embodiments, the request may include an application name and an identifier for the application. The identifier may be, for example, a version number of the application, a checksum associated with the application, a cryptographic hash associated with application, or a number of other possible identifiers. For instance, the application identifier may be a digital signature or certificate.

After receiving the request from the user, the computing device 105 may send the request for the application to an application source/server 125. The application source/server 125 may be, for example, an application store (such as the iPhone application store, or the like), a free-software site, or may simply be another user's computing device. The application source/server 125 can take a number of other appropriate forms as well. In response to the request, the application source/server 125 may send the requested application to the user device 105. In another implementation, for example, that relies on “pushing” applications to the user, rather than the user “pulling” applications from the server, the user may receive the application without having made a specific request for the application. In still another implementation, sending the application from the server to the 125 to the computing device 105 may also be omitted, for example, if the application is derived from another source, if the application is loaded directly on the computing device, for example, from a non-volatile storage medium, such as a flash memory drive or from a device that is not connected to the computing device 125 through the network cloud 115.

The user device 105, upon receiving the application from the application source/server 125, or upon being requested to load and run the application, may examine the application and obtain, from the application, one or more identifying attributes. For example, the computing device 105 may determine that a name associated with the application matches the requested application. The computing device 105 may also determine an identifier for the application, such as one of the examples discussed above (e.g., a version number, a checksum, a cryptographic hash, a digital signature, or a digital certificate). Thus, the determined identifier can be received from another device (e.g., from the source/server 125), can be generated by the user device 105, or a combination thereof. The computing device 105 may then search a list (e.g., a database or database record) of preapproved applications for the computing device 105 to determine if the list includes an entry that matches the identifying attributes of the received application. If the list of preapproved applications includes a matching entry, the computing device 105 would determine that the application is preapproved (whitelisted) and proceed to execute the application. As discussed above, in one embodiment, the list of preapproved applications may be provided to the computing device 105 from the authentication server 120.

If an entry matching the identifying attributes of the received application is not found in the list of preapproved applications, the user device 105 may determine that the application is not preapproved and, in response, request metrics associated with the application from one or more cloud-based sources. The user device 105 may use such metrics to make a decision whether or not to execute the received application. In one embodiment, the user device 105 may automatically request such metrics when a determination is made that an application is not whitelisted. In other embodiments, the user device 105 may provide the user with a notification that the received/requested application has not been preapproved for execution. The user may then request, in response to the notification, that metrics associated with the application be obtained in order to make a determination whether to approve/execute the application and, if approved, add the application to the list of whitelisted applications.

In the network 100, some example cloud-based sources for obtaining application metrics are shown. It will be appreciated that these sources are given by way of example, and other approaches for providing application metrics are possible. In the example embodiment illustrated in FIG. 1, the network 100 includes an application rating service 130, a social networking site 135 and a computing device 140.

As shown in FIG. 1, the application rating service may provide a Really Simple Syndication (RSS) feed 145 to the network cloud 115. A user of the computing device 105 (or user device 110) could subscribe to the RSS feed 145 and obtain metrics from the application rating service 130 via the RSS feed 145. The application rating service 130 may implemented in a number of fashions. For instance, the application rating service 130 may be implemented as a separate element of the network 100, as shown in FIG. 1. In other embodiments, the application rating service 130 may be implemented as part of an application source/server, such as the application source/server 125.

The metrics (ratings) provided by the application rating service 130 may take a number of forms. For instance, ratings provided by the rating service 130 may include overall quality ratings of applications, ratings related to security risks associated with applications, or may include a number of other possible ratings.

The social networking site 135 may also be used to provide application metrics to the user device 105 (or user device 110) in response to a request for such metrics. For instance, usage statistics for the application could be collected on the social networking site 135. In one embodiment, the social networking site 135, in response to a request from the user of the user device 105, may send usage statistics for the application to the user that have been collected from people that are in the user's social network. Such usage statistics may include statistics regarding how many of the user's social networking contacts have installed a particular application, how many of the user's social networking contacts are actively using the application (e.g., have used the application in the last week), how many of the user's social networking contacts installed but then removed the application, among a number of other possible usage statistics. The social network site 135 may also provide other metrics for the application, such as metrics/ratings related to application quality and/or security risks, such as were previously discussed.

The computing device 140 may provide application metrics to the user device 105 via a peer-to-peer (P2P) connection 150. In one embodiment, the computing device 140 may be a computing device that is owned or controlled by a person that the user knows, such as a friend or relative, from whom the user wishes to obtain metrics (e.g., ratings and/or usage statistics) for the application. In other embodiments, the computing device 140 may be owned or controlled by a person who is not known to the user.

In one embodiment, if a user makes a request to run an application on the user device 105 that is not listed in a list (e.g., a database record) of preapproved (whitelisted) applications for the computing device 105 (or an associated users cloud-based computing account), the user device 105 may obtain metrics from one or more such cloud-based sources, such as those discussed above, for example, and use the obtained metrics to determine whether or not to execute the application on the user device 105. If the user device 105 decides, based on the obtained metrics, to run the application, the user device 105 may also add the name of the application and an identifier for the application to a database record (list) of whitelisted (approved) applications for the user device 105 and/or the user's cloud-based computing account. In one implementation, the user device 105 may determine automatically, without user input, whether to run the application based on the obtained metrics. In another implementation, the obtained metrics may be presented to the user, and the user may determine whether, based on the obtained metrics, to cause the user device 105 to run the application. In still another implementation, the user device 105 may, based on the obtained metrics, provide a recommendation to the user whether or not to run the application, and the user may accept or override the recommendation.

In another implementation, the application need to be received at the user device 105 for the user device before the computing device 105 determines whether the application is listed on a whitelist and/or is identified by various metrics upon which the user device may determine that the application may be executed. In this manner the application may be vetted prior to being received by the computing device 105. For example, the computing device 105 may receive a request to execute an application and the may searches a list (e.g., a database or database record) of preapproved applications for the computing device 105 to determine if the list includes an entry that matches the identifying attributes of the requested application. If the list of preapproved applications includes a matching entry, the computing device 105 would determine that the application is preapproved (whitelisted) and proceed to then receive (e.g., download) and execute the application. As discussed above, in one embodiment, the list of preapproved applications may be provided to the computing device 105 from the authentication server 120.

If an entry matching the identifying attributes of the requested application is not found in the list of preapproved applications, the user device 105 may determine that the application is not preapproved and, in response, may request metrics associated with the application from one or more cloud-based sources. The user device 105 may use such metrics to make a decision to receive and then execute the received application. In one embodiment, the user device 105 may automatically request such metrics when a determination is made that an application is not whitelisted. In other embodiments, the user device 105 may provide the user with a notification that the received/requested application has not been preapproved for execution. The user may then request, in response to the notification, that metrics associated with the application be obtained in order to make a determination to receive and approve/execute the application and, when approved, add the application to the list of whitelisted applications. Thus, in such implementations, the application can be received (e.g., downloading) after the determination has been made to execute the application.

FIG. 2 is a diagram illustrating a server 200 and a database record 205 that may be stored in the server 200 in accordance with an example embodiment. The server 200 may be used to implement the authentication server 120 in FIG. 1, for example. Accordingly, for purposes of illustration, FIG. 2 will be described with further reference to FIG. 1. As shown in FIG. 2, the database record 205 includes a username 210 and a password 220. The username 210 and the password 220 may correspond with a cloud-based computing account assigned to a user/owner of the user devices 105 and 110 in the network 100.

The server 200 may receive authentication credentials from the user device 105 or the user device 110 via the network cloud 115. For purposes of illustration, FIG. 2 will be described with respect to using the user device 105 of FIG. 1. The server 200 may compare the received user credentials to a database of users (e.g., that includes a respective record 205 corresponding with each user having a cloud-based computing account on the server 200). If the received user credentials match the username 210 and password 220 in one of the database records 205, the user that sent the credentials may be authenticated by the server 200. Once the server 200 has authenticated that the received user credentials match the database record 205, the server 200 may send the database record 205 to the computing device 105.

The computing device 105 may use the database record 205 to determine whether applications that are requested to be executed on the computing device 105 are preapproved (whitelisted) for execution. An initial whitelist of preapproved applications may be generated, for example, based on information from a trusted source, such as an antivirus company. The database record can include a first application entry 230, which may be the name of a first application, and a first application identifier 240 corresponding with the application 230. The application identifier 240 (as well as application identifiers 260 and 280) may take a number of forms, such as those discussed above with respect to FIG. 1 (e.g., a version number, a checksum, a cryptographic hash, a digital signature, or a digital certificate). In like fashion, the database record 205 includes a second application entry 250, which may be the name of a second application, the second application identifier 260 corresponding with the application 250, a third application entry 270, which may be the name of a third application and the third application identifier 280 corresponding with the application 270.

In this situation, the computing device 105, if requested to run the applications 230, 250 or 270 may use the database record 205 received from the server 200 to determine that those particular applications are whitelisted (approved) for execution on the user device 105 and/or in association with the user's cloud-based computing account, (e.g., when the user is successfully logged into his or her cloud-based computing account). Accordingly, if the user device 105 receives a request to execute any (or all) of the applications 230, 250 or 270 after receiving the database record 205, using the techniques described herein, the computing device 105 would proceed to execute the applications 230, 250 and/or 270.

If, however, a request to execute an application 290 (which is not originally in the record 205) is received by the computing device 105, the computing device would determine that the application 290 is not whitelisted. The computing device 105 may then obtain metrics for the application 290, such as in the fashions described herein. The user device 105 may then make a determination whether to execute the application 290 based on one or more received metrics for the application 290. If the user device 105 makes a determination to execute the application 290, the computing device 105 may also add the application 290 (e.g., a name of the application 290) and a corresponding identifier 295 to the database record 205 that was received from the server 200, as is indicated in FIG. 2.

In this situation, after the database record 205 is updated to include the application indicator 290 and the identifier 295, the user device 105 may send the updated database record 205 back to the server 200 in order to update the database record 205 on the server 200. Using such an approach, a user may be provided with his or her most recent list of whitelisted application whenever he or she logs into a cloud-based computing device, no matter whether or not the user has previously used the particular computing device to access his or her cloud-based computing account.

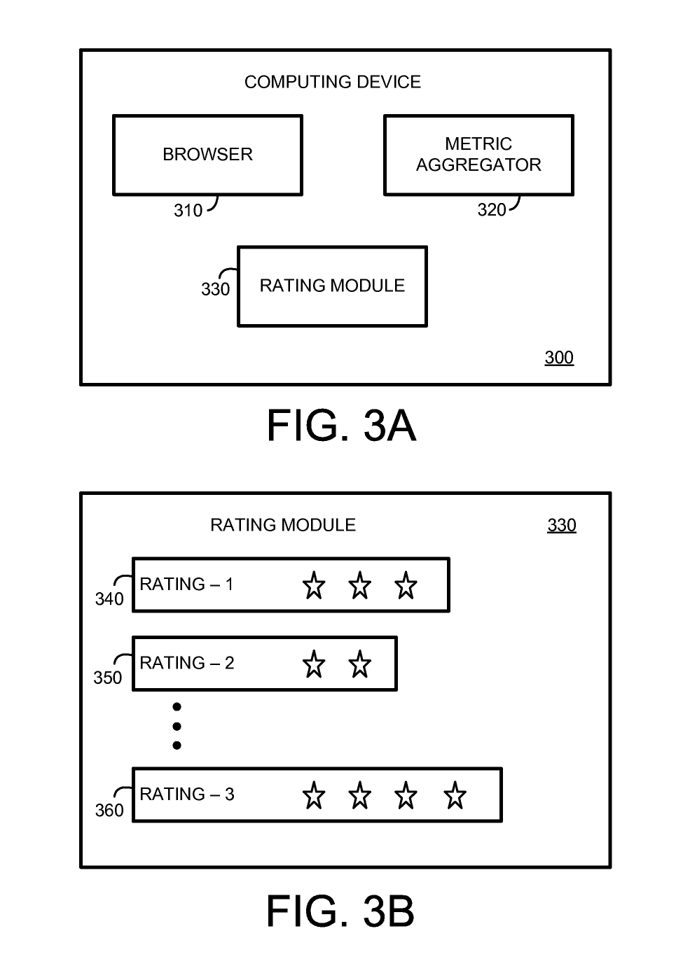

FIGS. 3A and 3B are diagrams illustrating a computing device 300 and a computer-implemented rating module 330 that may be used to implement the techniques described herein in accordance with an example embodiment. The computing device 300 shown in FIG. 3A may be used to implement the user computing devices 105 and 110 in FIG. 1. Further, the computing device 300 could also be used to implement the computing device 140 in the network 100. As illustrated in FIG. 3A, the computing device 300 includes a browser 310, a metric aggregator 320 and a rating module 330.

As was indicated above, the browser 310 may be used by a user to request that a particular cloud-based application be obtained (e.g., via the network cloud 115) for execution on the computing device 300, such as by clicking a link or using an icon associated with the requested application. As was also indicated above, the requested application may be a browser-based application that, when executed, is executed within the browser 310. In other embodiments, the requested application may be a conventional application that runs as an independent process on the computing device 300 and is not executed within the browser 310. The browser 310 may also be used to display a user interface for the rating module 330 in the computing device 300. An example embodiment of the rating module 330 is illustrated in FIG. 3B and described in further detail below.

The computing device 300 shown in FIG. 3A also includes a metric aggregator 320. The metric aggregator 320 may be configured to request application metrics from cloud-based sources, such as described herein. For instance, the metric aggregator 320 may allow for a user to set preferences for how application metrics are obtained and also set preferences for how received metrics are used to determine whether an application should be executed or not. For example, the metric aggregator may configured to obtain application metrics from application rating services (e.g., via RSS feeds), from social networking sites and/or over P2P connections, such as was previously discussed. The metric aggregator 320 may be configured to obtain application metrics in other fashions as well. In other embodiments, other elements of the computing system 300 may be used to request and receive application metrics from cloud-based sources.

In an example embodiment, the metric aggregator 320 may also be configured to aggregate a plurality of application metrics into one or more aggregated metrics. For instance, the computing device 300 may receive a plurality of overall quality ratings for an application from different application rating services. The metric aggregator 320 may be configured to aggregate the plurality of overall quality ratings to a single aggregated quality rating. The metric aggregator 320 may also be configured to aggregate other metrics as well, such as security risk metrics, usage statistics and other metrics that may be obtained for an application. Depending on the particular situation, the metric aggregator 320 may aggregate a plurality of metrics by computing an average (or averages) of those metrics. The metric aggregator 320, in this situation, may compute simple averages, or may compute weighted averages. The aggregated (e.g., average) metrics could then be compared to respective thresholds by the metric aggregator 320 as part of the determination of whether to approve the application for execution. Such an approach could be applied for a number of different metric types, such as security risk metrics, for example.

In other situations, the metric aggregator 320 may be configured to aggregate a plurality of metrics by accepting some metrics and ignoring others. For instance, the metric aggregator 320 may be configured to trust metrics from specific sources and rely on those metrics without considering similar metrics from other sources. For example, the metric aggregator 320 may be configured to trust application metrics received from Google. In this situation, if an overall quality rating for an application is received from Google, the metric aggregator 320 may consider the quality rating received from Google and disregard overall quality ratings received from other sources.

The above examples of metric aggregation are given by way of illustration. There are a number of approaches that could be used to aggregate and consider application metrics to determine whether or not an application is safe to execute. The specific approach may depend on the particular application, user preferences and/or available metrics, among a number of other factors. In one embodiment, the metric aggregator 320 may operate on the computing system 300 without user intervention. In other embodiments, the metric aggregator 320 may operate based on user preferences and may operate such that user interaction is requested (e.g., via a user interface) when requesting and/or aggregating application metrics.

FIG. 3B is a diagram illustrating an interface for a rating module 330 that may be used in the computing system 300. The rating module 330 may be used by a user to rate an application that the user has executed on the computing system 300. In one approach, the application may automatically request such ratings. In another approaches, the user may independently activate the rating module 330 to provide application ratings. For instance, the rating module 330 could be provided to the computing device 300 from an application source/server, such as the application source/server 125 illustrated in FIG. 1. In such an approach, the application source/server could automatically provide the rating module 330 or may provide the rating module 330 in response to a user request to provide application metrics/ratings.

As shown in FIG. 3B, the rating module 330 may allow a user to provide a plurality of ratings 340, 350 and 360 or metrics for an application. These ratings/metrics may be metrics such as those described above, or may be other metrics. For instance, if the application the user is providing ratings for is a video game, the ratings 340-360 may include ratings related to graphics quality, difficulty of play and computing performance, among a number of other ratings/metrics. Other types of applications may have other ratings/metrics that a user may provide. Once a user has provided ratings 340-360, those ratings may be published via a network cloud, such as in the fashions discussed above with respect to FIG. 1. For instance, the user ratings 340-360 could be sent to the application rating server 130 and published via the RSS feed 145. Alternatively, the ratings 340-360 could be collected by the social networking site 135 and provided to other users in the social network of the user that provided the ratings 340-360. In yet another embodiment, the ratings 340-360 could be provided to other users over a P2P connection. Other approaches for publishing the user ratings 340-360 also are possible. For example, the computing device 300 could directly publish the ratings, such as over a network feed (e.g., RSS feed or other feed type).

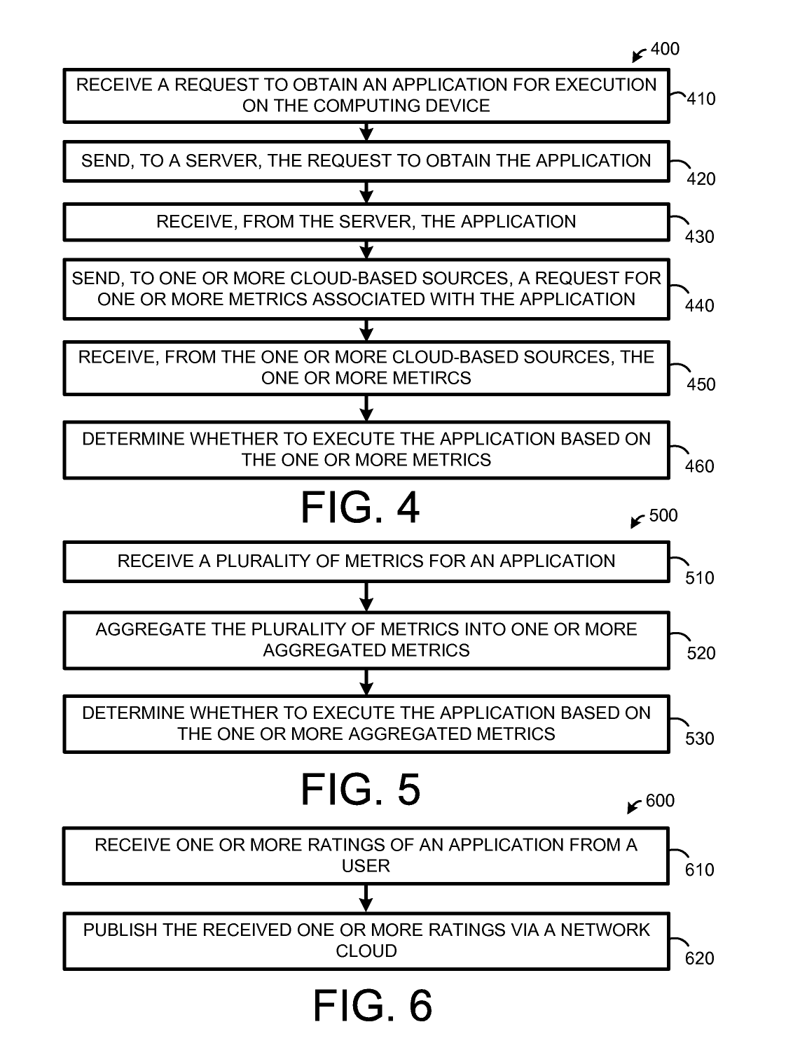

FIGS. 4-9 illustrate example methods for implementing the techniques described herein. The methods illustrated in FIG. 4-9 may be implemented using the approaches described above with respect to FIGS. 1-3. The methods illustrated in FIGS. 4-9 may be implemented in conjunction with one another, where appropriate, and the operations of those methods may be performed in any appropriate order. In certain embodiments, some operations of the methods illustrated in FIGS. 4-9 may be eliminated, while in other embodiments other operations may be added.

FIG. 4 is a flowchart illustrating a method 400 for executing an application in a cloud-based computing environment in accordance with an example embodiment. The method 400 includes, at block 410, receiving a request to obtain an application for execution on the computing device. The method 400 further includes, at block 420, sending, to a first server, the request to obtain the application. At block 430, the method 400 includes receiving, from the first server, the application. At block 440, the method 400 further includes sending, to one or more cloud-based sources, a request for one or more metrics associated with the application. The method 400 also includes, at block 450, receiving, from the one or more cloud-based sources, the one or more metrics. At block 460, the method 400 includes determining whether to execute the application based on the one or more metrics, such as using the approaches described herein.

FIG. 5 is a flowchart illustrating a method 500 for determining whether to approve an application for execution in accordance with an example embodiment. The method 500 includes, at block 510, receiving a plurality of metrics for an application. At block 520, the method 500 includes aggregating the plurality of metrics into one or more aggregated metrics, such as in the fashions discussed above. At block 530, the method 500 includes determining whether to execute the application based on the one or more aggregated metrics, such as in the manners described herein.

FIG. 6 is a flowchart illustrating a method 600 for publishing user metrics/ratings of an application in accordance with an example embodiment. The method 600 includes, at block 610, receiving, from a user, a user rating (or ratings) of the application. At block 620, the method 600 includes publishing the user rating(s) such that the user rating(s) is(are) available to at least one other user on a network cloud. For example, the user rating(s) may be published using a network feed, such as a RSS feed. Alternatively, the user rating(s) could be published using a P2P connection from a user's computing device to another user's computing device via the network cloud. In yet another embodiment, the user rating(s) may be sent to a cloud-based application rating service server for publication by that server, such as along with other users' ratings.

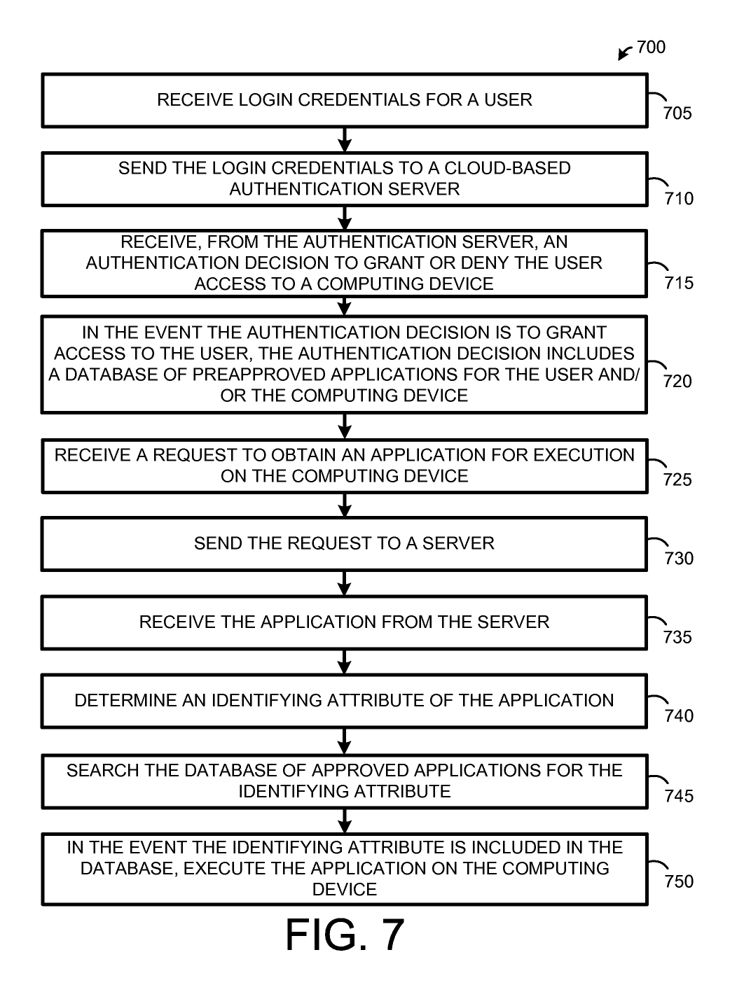

FIG. 7 is a flowchart illustrating a method 700 for determining whether to approve an application for execution in accordance with an example embodiment. The method 700 includes, at block 705, receiving login credentials for a user. At block 710, the method 700 includes sending the login credentials to a cloud-based authentication server. At block 715, the method 700 includes, receiving, from the authentication server, an authentication decision to grant or deny the user access to a cloud-based computing device. At block 720, in the event the authentication decision is to grant access to the user, the authentication decision of the method 700 includes a database of preapproved applications, such as the database record 205 discussed above with respect to FIG. 2.

At block 725, the method 700 includes, receiving a request to obtain an application for execution on the cloud based computing device. The method 700 further includes, at block 730, sending the request to a server, such as the application source/server 125 shown in FIG. 1. At block 735, the method 700 includes receiving the application from the server. At block 740, the method 700 includes determining an identifying attribute of the application, such as those that were previously discussed. The method 700 further includes, at block 745, searching the database of approved applications for the identifying attribute. At block 750, in the event the identifying attribute is included in the database, the method 700 includes executing the application.

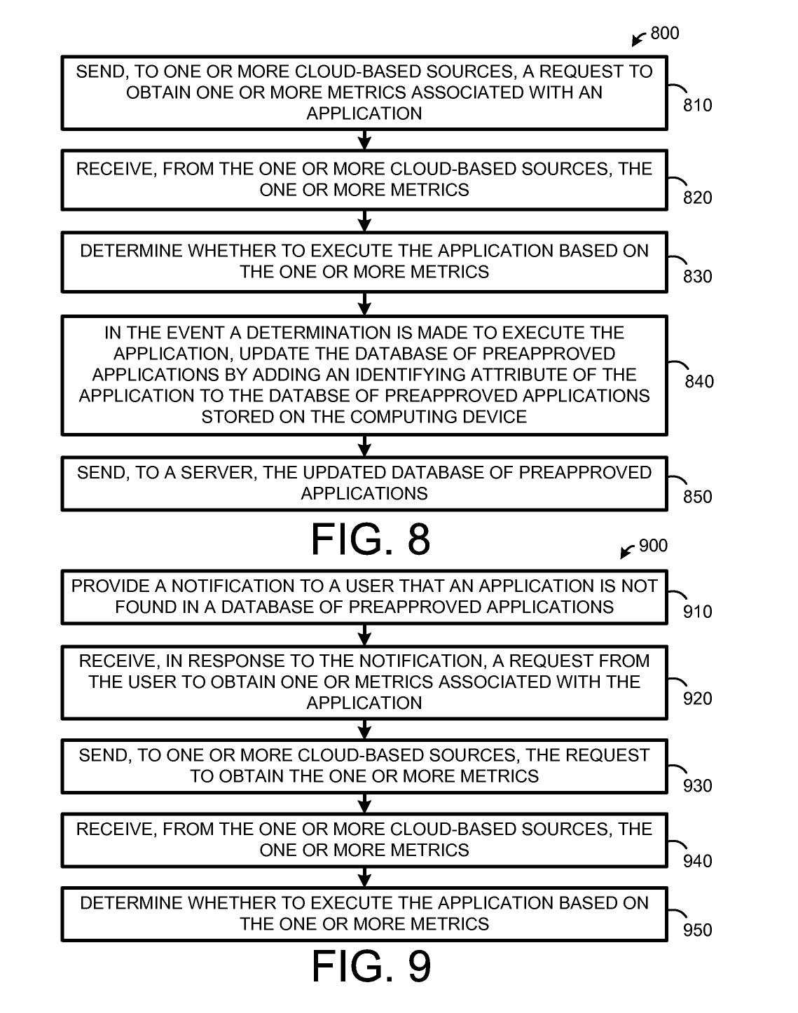

FIG. 8 is a flowchart illustrating a method 800 for obtaining metrics for an application, determining whether to execute the application based on the metrics and adding an approved application to a database of approved applications in accordance with an example embodiment. The method 800 includes, at block 810, sending, to one or more cloud-based sources, a request to obtain one or more metrics associated with the application. At block 820, the method 800 includes receiving the one or more metrics from the one or more cloud-based sources. At block 830, the method 800 includes determining whether to execute the application based on the one or more metrics, such as using the techniques described herein. At block 840, in the event the computing device makes a determination to execute the application, the method 800 further includes updating the database of preapproved applications by adding an identifying attribute of the application to the database of preapproved applications stored on the computing device. At block 850, the method 800 further includes sending the updated database of preapproved applications to a second server, e.g., an authentication server.

FIG. 9 is a flowchart illustrating another method 900 for obtaining metrics for an application and determining whether to execute the application based on the metrics in accordance with an example embodiment. The method 900 includes, at block 910, providing a notification to a user that the application is not preapproved, e.g., is not listed in a database record of preapproved applications. At block 920, the method 900 includes receiving, in response to the notification, a request from the user to obtain one or metrics associated with the application. At block 930, the method 900 includes sending, to one or more cloud-based sources, the request to obtain the one or more metrics. The method 900 further includes, at block 940, receiving the one or more metrics from the one or more cloud-based sources. At block 950, the method 900 includes determining whether to execute the application based on the one or more metrics.

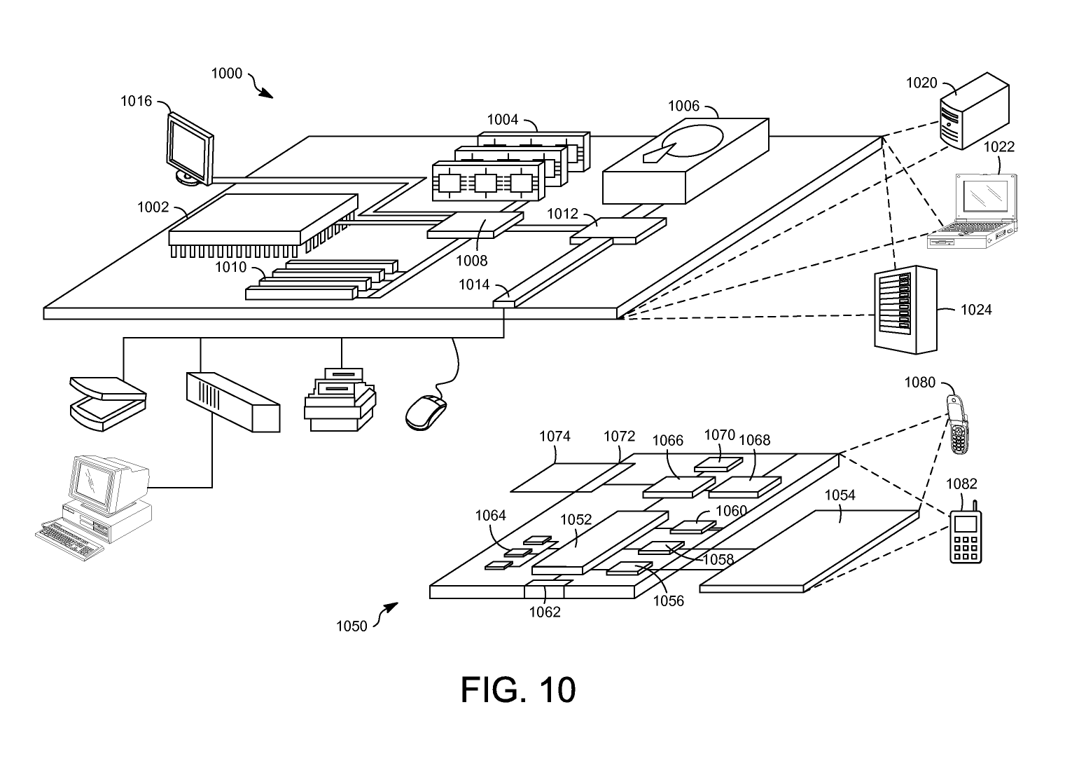

FIG. 10 is a diagram that shows an example of a generic computer device 1000 and a generic mobile computer device 1050, which may be used with the techniques described here. Computing device 1000 is intended to represent various forms of digital computers, such as laptops, desktops, workstations, personal digital assistants, servers, blade servers, mainframes, and other appropriate computers. Computing device 1050 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1000 includes a processor 1002, memory 1004, a storage device 1006, a high-speed interface 1008 connecting to memory 1004 and high-speed expansion ports 1010, and a low speed interface 1012 connecting to low speed bus 1014 and storage device 1006. Each of the components 1002, 1004, 1006, 1008, 1010, and 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as display 1016 coupled to high speed interface 1008. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1004 stores information within the computing device 1000. In one implementation, the memory 1004 is a volatile memory unit or units. In another implementation, the memory 1004 is a non-volatile memory unit or units. The memory 1004 may also be another form of computer-readable medium, such as a magnetic or optical disk.

The storage device 1006 is capable of providing mass storage for the computing device 1000. In one implementation, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1004, the storage device 1006, or memory on processor 1002.

The high speed controller 1008 manages bandwidth-intensive operations for the computing device 1000, while the low speed controller 1012 manages lower bandwidth-intensive operations. Such allocation of functions is exemplary only. In one implementation, the high-speed controller 1008 is coupled to memory 1004, display 1016 (e.g., through a graphics processor or accelerator), and to high-speed expansion ports 1010, which may accept various expansion cards (not shown). In the implementation, low-speed controller 1012 is coupled to storage device 1006 and low-speed expansion port 1014. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a display 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can execute instructions within the computing device 1050, including instructions stored in the memory 1064. The processor may be implemented as a chipset of chips that include separate and multiple analog and digital processors. The processor may provide, for example, for coordination of the other components of the device 1050, such as control of user interfaces, applications run by device 1050, and wireless communication by device 1050.

Processor 1052 may communicate with a user through control interface 1058 and display interface 1056 coupled to a display 1054. The display 1054 may be, for example, a TFT LCD (Thin-Film-Transistor Liquid Crystal Display) or an OLED (Organic Light Emitting Diode) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may be provide in communication with processor 1052, so as to enable near area communication of device 1050 with other devices. External interface 1062 may provide, for example, for wired communication in some implementations, or for wireless communication in other implementations, and multiple interfaces may also be used.

The memory 1064 stores information within the computing device 1050. The memory 1064 can be implemented as one or more of a computer-readable medium or media, a volatile memory unit or units, or a non-volatile memory unit or units. Expansion memory 1074 may also be provided and connected to device 1050 through expansion interface 1072, which may include, for example, a SIMM (Single In Line Memory Module) card interface. Such expansion memory 1074 may provide extra storage space for device 1050, or may also store applications or other information for device 1050. Specifically, expansion memory 1074 may include instructions to carry out or supplement the processes described above, and may include secure information also. Thus, for example, expansion memory 1074 may be provide as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1064, expansion memory 1074, or memory on processor 1052, which may be received, for example, over transceiver 1068 or external interface 1062.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, WiFi, or other such transceiver (not shown). In addition, GPS (Global Positioning System) receiver module 1070 may provide additional navigation- and location-related wireless data to device 1050, which may be used as appropriate by applications running on device 1050.

Device 1050 may also communicate audibly using audio codec 1060, which may receive spoken information from a user and convert it to usable digital information. Audio codec 1060 may likewise generate audible sound for a user, such as through a speaker, e.g., in a handset of device 1050. Such sound may include sound from voice telephone calls, may include recorded sound (e.g., voice messages, music files, etc.) and may also include sound generated by applications operating on device 1050.

The computing device 1050 may be implemented in a number of different forms, as shown in the figure. For example, it may be implemented as a cellular telephone 1080. It may also be implemented as part of a smart phone 1082, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
receiving, by a computing device, a request to execute an application on the computing device;
sending, by a processor of the computing device to one or more cloud-based sources, a request for a plurality of metrics associated with the application, the request including an identifying attribute of the application;
receiving, by the computing device from the one or more cloud-based sources, the plurality of metrics; and
determining, by a processor of the computing device, whether to execute the application based on the plurality of metrics.

2. The computer-implemented method of claim 1, wherein the one or more cloud-based sources includes at least one of an application rating service, a social networking service and a peer-to-peer connection.

3. The computer-implemented method of claim 1, wherein in the event the computing device makes a determination to execute the application, the method further comprises adding, by the computing device, an identifying attribute of the application to a database of preapproved applications stored on the computing device.

4. The computer-implemented method of claim 3, further comprising sending, by the computing device to a second server, the database of preapproved applications.

5. The computer-implemented method of claim 1, wherein the identifying attribute comprises at least one of a version number, a checksum value and a cryptographic hash value of the application.

6. The computer-implemented method of claim 1, wherein the one or more metrics comprise at least one of a usage statistic for the application, a rating for the application and an indication of a security-risk level for the application.

7. The computer-implemented method of claim 1, further comprising aggregating the plurality of metrics to generate an aggregated metric, and wherein determining whether to execute the application based on the plurality of metrics comprises: determining whether to execute the application based on the aggregated metric.

8. The computer-implemented method of claim 7, wherein aggregating the plurality of metrics comprises determining an aggregate usage statistic based on two or more usage statistics for the application.

9. The computer-implemented method of claim 7, wherein aggregating the plurality of metrics comprises determining an aggregate indication of security risk for the application based on two or more indications of security risk for the application.

10. The computer-implemented method of claim 1, wherein receiving the plurality of metrics comprises receiving least one metric via a Really Simple Syndication (RSS) feed.

11. The computer-implemented method of claim 1, further comprising:
receiving, by the computing device from a user, a user rating of the application; and
publishing, by the computing device, the user rating such that the user rating is available to at least one other user on a network cloud.

12. The computer-implemented method of claim 11, wherein publishing the user rating comprises publishing the user rating via a Really Simple Syndication (RSS) feed.

13. The computer-implemented method of claim 11, wherein publishing the user rating comprises publishing the user rating via a peer-to-peer connection.

14. The method of claim 1, further comprising receiving, based on the plurality of metrics, the application at the computing device after the determination to execute the application.

15. A computer-implemented method comprising:
receiving, at a cloud-based computing device, a request to obtain an application for execution on the cloud based computing device;
sending, from the computing device to a server, the request;
receiving, by the computing device from the server, the application;
determining, by a processor of the computing device, an identifying attribute of the application;
searching, by the computing device, a database of approved applications for the identifying attribute;
in the event the identifying attribute is included in the database, executing the application by a processor of the computing device;
in the event the identifying attribute is not included in the database, the method further comprises:
sending, by the computing device to one or more cloud-based sources, a request to obtain a plurality of metrics associated with the application;
receiving, by the computing from the one or more cloud-based sources, the a plurality of metrics; and
determining, by the computing device, whether to execute the application based on the a plurality of metrics.

16. The computer-implemented method of claim 15, wherein prior to receiving the request to obtain the application, the method further comprises:
receiving, at the computing device, login credentials for the user;
sending, from the computing device to a cloud-based authentication server, the login credentials; and
receiving, from the authentication server at the computing device, an authentication decision to grant or deny the user access to the computing system,
wherein in the event the authentication decision is to grant access to the user, the authentication decision includes the database of preapproved applications.

17. The computer-implemented method of claim 16, wherein in the event the computing device makes a determination to execute the application, the method further comprises updating, by the computing device, the database of preapproved applications by adding an identifying attribute of the application to the database of preapproved applications.

18. The computer-implemented method of claim 17, further comprising sending, by the computing device to authentication server, the updated database of preapproved applications.

19. The computer-implemented method of claim 15, wherein in the event the computing device makes a determination to execute the application, the method further comprises updating, by the computing device, the database of preapproved applications by adding an identifying attribute of the application to the database of preapproved applications stored on the computing device.

20. The computer-implemented method of claim 19, further comprising sending, by the computing device to a second server, the updated database of preapproved applications.

21. The computer-implemented method of claim 15, wherein prior to receiving the request to obtain the application, the method further comprises:
receiving, at the computing device, login credentials for the user;
sending, from the computing device to a cloud-based authentication server, the login credentials; and
receiving, from the authentication server at the computing device, an authentication decision to grant or deny the user access to the computing system,
wherein in the event the authentication decision is to grant access to the user, the authentication decision includes the database of preapproved applications.

22. The computer-implemented method of claim 15, wherein in the event the identifying attribute is not included in the database, the method further comprises:
providing, by the computing device, a notification to a user that the application is not preapproved;
receiving, by the computing device in response to the notification, a request from the user to obtain one or metrics associated with the application;
sending, by the computing device to one or more cloud-based sources, the request to obtain the one or more metrics;
receiving, by the computing from the one or more cloud-based sources, the one or more metrics; and
determining, by the computing device, whether to execute the application based on the one or more metrics.

23. A machine readable storage medium having instructions stored thereon, the instructions, when executed by a processor of a computing device, cause the computing device to:
receive a request to obtain an application for execution on the computing device;
send, to one or more cloud-based sources, a request for a plurality of metrics associated with the application, the request including an identifying attribute of the application;
receive, from the one or more cloud-based sources, the plurality of metrics; and
determine whether to execute the application based on the plurality of metrics.

24. A machine readable storage medium having instructions stored thereon, the instructions, when executed by a processor of a computing device, cause the computing device to:
receive a request to obtain an application for execution on the computing device;
send the request to a server;
receive the application from the server;
determine an identifying attribute of the application;
search a database of approved applications for the identifying attribute;
in the event the identifying attribute is included in the database, execute the application; and
in the event the identifying attribute is not included in the database, the method further comprises:
send, by the computing device to one or more cloud-based sources, a request to obtain a plurality of metrics associated with the application;
receive, by the computing from the one or more cloud-based sources, the a plurality of metrics; and
determine, by the computing device, whether to execute the application based on the a plurality of metrics.

25. A system comprising one or more processors configured to (a) receive a request to obtain an application for execution on the computing device, (b) send, to one or more cloud-based sources, a request for a plurality of metrics associated with the application, the request including an identifying attribute of the application, (c) receive, from the one or more cloud-based sources, the plurality of metrics, and (d) determine whether to execute the application based on the plurality of metrics.

26. A system comprising one or more processors configured to (a) receive a request to obtain an application for execution on the cloud based computing device, (b) send, from the computing device to a server, the request, (c) receive, by the computing device from the server, the application, (d) determine, by a processor of the computing device, an identifying attribute of the application; (e) search a database of approved applications for the identifying attribute, (d) in the event the identifying attribute is included in the database, execute the application by a processor of the computing device,
wherein the one or more processors are further configured to, in the event the identifying attribute is not included in the database, (a) send to one or more cloud-based sources, a request to obtain a plurality of metrics associated with the application, (b) receive, by the computing from the one or more cloud-based sources, the a plurality of metrics; and
wherein one or more processors are further configured to, in the event the identifying attribute is not included in the database, determine whether to execute the application based on the a plurality of metrics.
